(19) United States
(12) Patent Application Publication
(10) Pub. No.: US 2016/0198084 A1
(43) Pub. Date: Jul. 7, 2016

(54) IMAGE PICKUP APPARATUS, OPERATION SUPPORT METHOD, AND MEDIUM RECORDING OPERATION SUPPORT PROGRAM

(71) Applicant: OLYMPUS CORPORATION, Tokyo (JP)

(72) Inventors: Kazuhiko SHIMURA, Tokyo (JP); Yoshiyuki FUKUYA, Sagamihara-shi (JP); Kazuo KANDA, Tokyo (JP); Nobuyuki SHIMA, Tokyo (JP)

(73) Assignee: OLYMPUS CORPORATION, Tokyo (JP)

(21) Appl. No.: 14/971,467

(22) Filed: Dec. 16, 2015

(30) Foreign Application Priority Data
Jan. 6, 2015 (JP) 2015-001055

(51) Int. Cl. H04N 5/232; G01C 3/32

(52) U.S. Cl. CPC H04N 5/23212; H04N 5/23293; G01C 3/32

(57) ABSTRACT

An image pickup apparatus includes: an image pickup portion that obtains an image pickup image based on an object optical image obtained by an optical system that can vary a focus position; an object distance determination portion that determines an object distance of each portion in the image pickup image; a continuity determination portion that determines the continuity of the object distance and the image pickup image; and a display control portion that, in a depth synthesis mode that subjects a plurality of image pickup images that are obtained while varying a focus position of the optical system to depth synthesis, based on a determination result with respect to the continuity, causes a guide display for supporting the depth synthesis operation to be displayed on a display portion.

### CROSS REFERENCE TO RELATED APPLICATION

This application claim is benefit of Japanese Application No. 2015-001055 in Japan on Jan. 6, 2015, the contents of which are incorporated by this reference.

### BACKGROUND OF THE INVENTION

1. Field of the Invention

The present invention relates to an image pickup apparatus that is capable of depth synthesis photographing, an operation support method, and a medium that records an operation support program.

2. Description of the Related Art

In recent years, portable devices with a photographing function (image pickup apparatuses) such as digital cameras have come into widespread use. Such kinds of image pickup apparatuses include apparatuses that are equipped with a display portion and that have a function that displays a photographic image. In addition, such image pickup apparatuses include apparatuses that display a menu screen on a display portion to facilitate operation of the image pickup apparatus.

Some image pickup apparatuses are also equipped with an auto-focus function that automates focusing, or an automatic exposure adjustment function that automates exposure. Automatic focus adjustment and automatic exposure adjustment are possible almost without the user being aware of the focusing or exposure adjustment.

With respect to the auto-focus function, for example, a technique is adopted that focuses on an object at the center of the screen or on an object that the user designates, or determines the distance to objects at each portion of the screen and focuses on the nearest object. However, when only the auto-focus function is used, it is not necessarily the case that focusing is performed in accordance with the desire of the user. For example, depending on the depth of field, in some cases photographing is not performed in the focus state desired by the user.

Therefore, Japanese Patent Application Laid-Open Publication No. 2014-131188 discloses technology that enables photographing of an image in which the background is blurred, without the need to perform a complicated operation. According to this technology, it is determined whether or not it is possible to distinguish between regions according to the depth of field, and if it is determined that distinguishing between regions is not possible, a focal distance is changed to a focal distance at which it is possible to distinguish between regions, and a first image and a second image are obtained using the focal distance after the change.

Moreover, even if the auto-focus function is utilized, it is not necessarily the case that the entire object will be brought into focus. For example, even in a case where it is desired to bring an entire object into focus, depending on the depth of field, in some cases an image is photographed in which only part of the object is brought into focus, and the remaining part is out of focus. Therefore, in recent years, image pickup apparatuses which are capable of depth synthesis that synthesizes a plurality of image pickup images obtained by performing photographing a plurality of times while changing a focus position have been made commercially available. By utilizing an image pickup apparatus having a depth synthesis function, it is also possible to obtain an image in which entire object that a user wants to bring into focus is brought into focus.

### SUMMARY OF THE INVENTION

An image pickup apparatus according to the present invention includes: an image pickup portion that obtains an image pickup image based on an object optical image obtained by an optical system that can vary a focus position; an object distance determination portion that determines an object distance of each portion in the image pickup image; a continuity determination portion that determines continuity of the object distance and the image pickup image; and a display control portion that, in a depth synthesis mode that subjects a plurality of image pickup images that are obtained while varying a focus position of the optical system to depth synthesis, based on a determination result with respect to the continuity, causes a guide display for supporting the depth synthesis operation to be displayed on a display portion.

Further, an operation support method according to the present invention: determines an object distance of each portion in an image pickup image from an image pickup portion that obtains the image pickup image based on an object optical image obtained by an optical system that can vary a focus position; determines continuity of the object distance and the image pickup image; and in a depth synthesis mode that subjects a plurality of image pickup images that are obtained while varying a focus position of the optical system to depth synthesis, based on a determination result with respect to the continuity, causes a guide display for supporting the depth synthesis operation to be displayed on a display portion.

Furthermore, a medium that records an operation support program according to the present invention is a medium that records an operation support program for causing a computer to execute the steps of: determining an object distance of each portion in an image pickup image from an image pickup portion that obtains the image pickup image based on an object optical image obtained by an optical system that can vary a focus position; determining continuity of the object distance and the image pickup image; and in a depth synthesis mode that subjects a plurality of image pickup images that are obtained while varying a focus position of the optical system to depth synthesis, based on a determination result with respect to the continuity, causing a guide display for supporting the depth synthesis operation to be displayed on a display portion.

The above and other objects, features and advantages of the invention will become more clearly understood from the following description referring to the accompanying drawings.

### BRIEF DESCRIPTION OF THE DRAWINGS

FIG. 1 is a block diagram illustrating the circuit configuration of an image pickup apparatus according to one embodiment of the present invention;

FIG. 2 is an explanatory drawing for describing information regarding feature portions that are set as focus information acquisition positions;

FIG. 3 is a flowchart for describing operations of the embodiment;

FIG. 4 is an explanatory drawing illustrating a way in which article photographing is performed;

FIG. 5 is a flowchart illustrating an example of specific processing in step S7 in FIG. 3;

FIG. 6A and FIG. 6B are explanatory drawings illustrating display examples of focus setting displays; and

FIG. 7 is an explanatory drawing illustrating a change in the contrast of an image pickup image that is caused by depth synthesis.

### DETAILED DESCRIPTION OF THE PREFERRED EMBODIMENTS

Hereunder, embodiments of the present invention are described in detail with reference to the accompanying drawings.

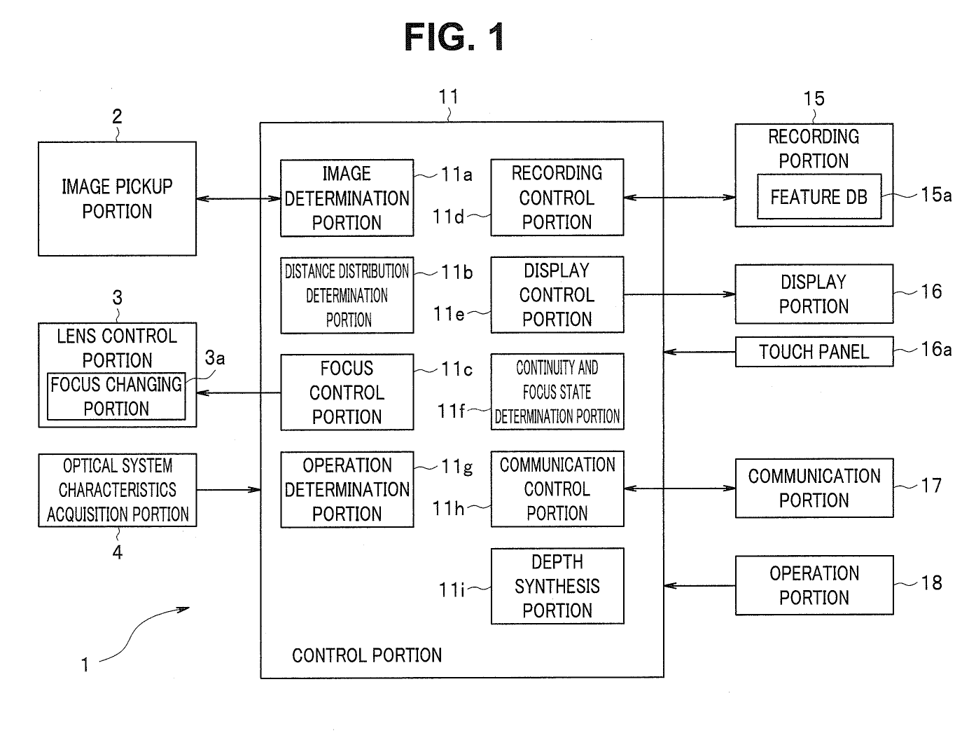

FIG. 1 is a block diagram illustrating the circuit configuration of an image pickup apparatus according to one embodiment of the present invention. An image pickup apparatus according to the present embodiment performs image pickup control for depth synthesis with respect to an image pickup portion, and is also configured to be capable of displaying a guide display (operation support display) for guiding a depth synthesis operation on a display portion.

In FIG. 1, an image pickup portion 2 is provided in an image pickup apparatus 1. The image pickup portion 2 includes an unshown image pickup device such as a CCD or a CMOS sensor, and an unshown optical system that guides an optical image of an object to an image pickup surface of the image pickup device. The optical system includes lenses and the like for zooming and focusing, and the lenses are configured to be subjected to driving control by a lens control portion 3. A focus changing portion 3a of the lens control portion 3 is configured to be capable of changing a focus position by driving lenses for focusing based on a control signal from a focus control portion 11c of a control portion 11 that is described later. Note that, as the image pickup device adopted in the image pickup portion 2, a device may be adopted that has pixels for focus control (hereunder, referred to as “AF pixels”) for determining a defocus amount according to an image plane phase difference method.

Further, an optical system characteristics acquisition portion 4 is configured to acquire information relating to the characteristics of the optical system, and output the information to the control portion 11. Note that information relating to the characteristics of the optical system includes information required for depth synthesis and a guide display that are described later, for example, information that shows the relation between distance and focus position when focusing, depth of field information, and information regarding a range in which focusing is possible. Further, as information relating to the characteristics of the optical system, the optical system characteristics acquisition portion 4 is configured to be capable of acquiring information in which the focal distance and state of the diaphragm are reflected.

The control portion 11, for example, can be constituted by an unshown processor such as a CPU that performs camera control in accordance with a program stored in an unshown memory. The control portion 11 outputs a drive signal for the image pickup device to the image pickup portion 2 to control a shutter speed, exposure time, and the like, and also reads out a photographic image from the image pickup portion 2. The control portion 11 subjects the photographic image that is read out to predetermined signal processing, for example, color adjustment processing, matrix conversion processing, noise elimination processing, and various other kinds of signal processing.

An operation determination portion 11g is provided in the control portion 11. The operation determination portion 11g is configured to accept a user operation at an operation portion 18 that includes a shutter button, a function button, and various kinds of switches for photographing mode settings or the like that are not illustrated in the drawings. The control portion 11 controls the respective portions based on a determination result of the operation determination portion 11g. A recording control portion 11d can perform compression processing on an image pickup image after the image pickup image undergoes various kinds of signal processing, and can supply the compressed image to a recording portion 15 and cause the recording portion 15 to record the compressed image.

A display control portion 11e of the control portion 11 executes various kinds of processing relating to display. The display control portion 11e can supply a photographic image that has undergone signal processing to a display portion 16. The display portion 16 has a display screen such as an LCD, and displays an image that is received from the display control portion 11e. The display control portion 11e is also configured to be capable of displaying various menu displays and the like on the display screen of the display portion 16.

A touch panel 16a is provided on the display screen of the display portion 16. The touch panel 16a can generate an operation signal in accordance with a position on the display screen that a user designates using a finger. The operation signal is supplied to the control portion 11. By this means, the control portion 11 can detect a position on the display screen that the user touches or a slide operation in which the user slides a finger over the display screen, and can execute processing that corresponds to the user operation.

Note that the display screen of the display portion 16 is provided along a back face of a main body portion 10, and the photographer can check a through image that is displayed on the display screen of the display portion 16 at a time of photographing, and can also perform a photographing operation while checking the through image.

In the present embodiment, to improve usability in a depth synthesis mode, for example, a display showing how to adjust the focus by means of the depth synthesis mode as well as whether or not adjustment is possible and the like is displayed as a guide display (operation support display) on a through image that is displayed on the display screen of the display portion 16. An image determination portion 11a, a distance distribution determination portion 11b, a continuity and focus state determination portion 11f as well as a depth synthesis portion 11i are provided in the control portion 11 for the purpose of realizing this kind of operation support display.

The image determination portion 11a performs image analysis with respect to an image pickup image from the image pickup portion 2, and outputs the analysis result to the continuity and focus state determination portion 11f. Further, by using the AF pixels, the distance distribution determination portion 11b can calculate an object distance at each portion of an image pickup image. Note that, in a case where the configuration of the image pickup device does not include AF pixels, the distance distribution determination portion 11b may be configured to calculate an object distance at each portion by a hill-climbing method that determines the contrast based on an image pickup image. The distance distribution determination portion 11b supplies the distance determination result to the continuity and focus state determination portion 11f.

The continuity and focus state determination portion 11f detects an image portion of an object (hereunder, referred to as “synthesis target object”) in which the same physical object or contour continues, based on an image analysis result and a distance determination result with respect to the image pickup image. Note that, together with determining a contour line, the continuity and focus state determination portion 11f may also determine a synthesis target object based on a change in an object distance on a contour line. For example, in a case where a change in the object distance is greater than a predetermined threshold value, the continuity and focus state determination portion 11f may determine that the contour is discontinuous.

Further, the continuity and focus state determination portion 11f may detect the synthesis target object using a feature value with respect to the object. For example, information of the feature value of the object may be recorded in a feature database (DB) 15a of the recording portion 15. The continuity and focus state determination portion 11f may read out a feature value from the feature DB 15a, and may detect the synthesis target object using the feature value. In addition, the continuity and focus state determination portion 11f may be configured to determine a synthesis target object by means of a user operation that specifies an object.

For each portion of an image, the continuity and focus state determination portion 11f determines an amount of focus deviation based on information from the distance distribution determination portion 11b and the optical system characteristics acquisition portion 4. The continuity and focus state determination portion 11f determines that an image portion is in focus if the amount of focus deviation for the relevant portion on the synthesis target object is within a predetermined region, and outputs focus information indicating that the position of the relevant portion on the image is in focus to the display control portion 11e. Further, with respect to a position on the image of an image portion that is determined to be out of focus on the synthesis target object, the continuity and focus state determination portion 11f outputs focus information indicating that the relevant portion is unfocused information to the display control portion 11e.

For example, a configuration may be adopted in which the continuity and focus state determination portion 11f sets a position at which to determine focus information on the synthesis target object (hereunder, referred to as “focus information acquisition position”) in advance, and if it is determined that the relevant image portion is in focus at the focus information acquisition position, the continuity and focus state determination portion 11f outputs focus information indicating that the relevant position is in focus, while if it is determined that the relevant image portion is out of focus, the continuity and focus state determination portion 11f outputs focus information indicating that the relevant position is not in focus. For example, a configuration may be adopted in which three places, namely, both edges and the center of a synthesis target object are set as focus information acquisition positions, and focus information regarding whether or not these three places are in focus is outputted to the display control portion 11e.

Note that it is also possible to set a focus information acquisition position by a setting operation performed by the user. Further, the continuity and focus state determination portion 11f may set an image portion (feature portion) having a predetermined feature of a synthesis target object as a focus information acquisition position. For example, a configuration may be adopted in which the feature database (DB) 15a of the recording portion 15 holds information regarding feature portions that are set as focus information acquisition positions. The continuity and focus state determination portion 11f may read out the information regarding the feature portions from the feature DB 15a, and may detect as a feature portion a portion of an image feature in a synthesis target object that is specified by the information regarding the feature portions to thereby determine a focus information acquisition position. Note that the contents of the feature DB 15a may be configured to be changeable by a user operation.

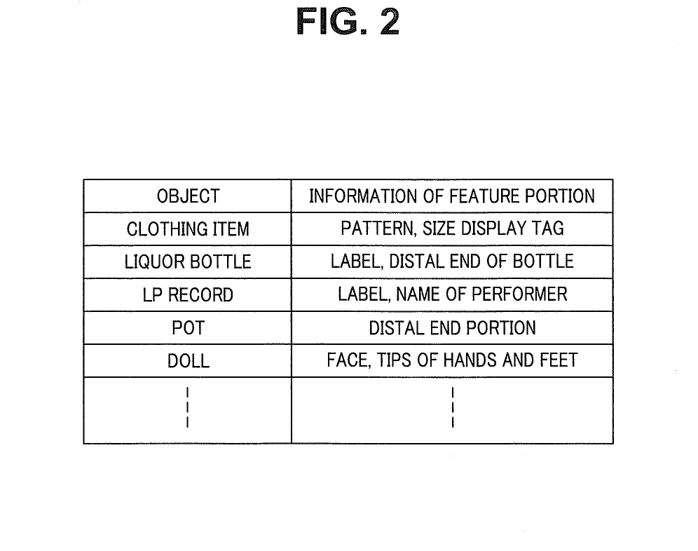

FIG. 2 is an explanatory drawing for describing information regarding feature portions that are set as focus information acquisition positions. The example in FIG. 2 illustrates a case where feature portion information is set for each kind of synthesis target object. In FIG. 2, a clothing item, a liquor bottle, an LP record, a pot and a doll are described as examples of synthesis target objects. For example, in FIG. 2, it is shown that in a case where the synthesis target object is a liquor bottle, a label part and a distal end of the bottle are set as feature portions. For example, upon determining that the synthesis target object is a liquor bottle based on feature values that are read out from the feature DB 15a, the continuity and focus state determination portion 11f reads out the feature portion information that is specified for the liquor bottle from the feature DB 15, and sets the label part and the distal end portion of the liquor bottle as focus information acquisition positions.

Note that, as the feature portion information, regardless of the kind of synthesis target object, a portion may be specified that is considered to be a portion in the image that the user wishes to view, such as an out-of-focus portion, a character portion, a portion in which there is a change in color, or a portion in which there is a change in shading.

The display control portion 11e is configured to receive focus information with respect to a focus information acquisition position, and at a time of operation in the depth synthesis mode, to display a display (hereunder, referred to as “focus setting display”) that is in accordance with the focus information as an operation support display at an image portion corresponding to the focus information acquisition position on a through image. The focus setting display is a display for showing the focus state at the focus information acquisition position, and is also used for specifying a position that the user wishes to bring into focus in the depth synthesis mode.

That is, in the depth synthesis mode in the present embodiment, the user can specify a focus position for depth synthesis processing that performs photographing a plurality of times while changing the focus position. For example, by touching a focus setting display on the touch panel 16a, the user can specify that a focus information acquisition position corresponding to the relevant focus setting display be brought into focus. The touch panel 16a is configured to be capable of outputting a focus information acquisition position specified by the user to the continuity and focus state determination portion 11f as a specified focusing position. Upon receiving information regarding a specified focusing position that is based on a specification operation of the user on the touch panel 16a, the continuity and focus state determination portion 11f can set a focus position corresponding to the distance of the specified focusing position in the focus control portion 11c.

The focus control portion 11c generates a control signal for focusing control with respect to the optical system of the image pickup portion 2 to the lens control portion 3. The focus control portion 11c is configured to be capable of performing focus control for depth synthesis. For example, upon receiving focus position information corresponding to a specified focusing position from the continuity and focus state determination portion 11f, the focus control portion 11c sets a focus position corresponding to the specified focusing position as a focus position at a time of depth synthesis. By this means, photographing is performed at the focus position corresponding to the specified focusing position at the time of depth synthesis. The control portion 11 can record image pickup images acquired by photographing a plurality of times during the depth synthesis mode in the recording portion 15 by means of the recording control portion 11d.

The depth synthesis portion 11i is configured to read out a plurality of image pickup images that are obtained in the depth synthesis mode from the recording portion 15, perform depth synthesis using the plurality of image pickup images that are read out, and supply a synthesized image obtained as a result of the synthesis to the recording control portion 11d and cause the recording portion 15 to record the synthesized image.

Note that, although the example in FIG. 1 describes a case in which the control portion 11 includes the depth synthesis portion 11i, a configuration may also be adopted in which the control portion 11 reads out a plurality of image pickup images that are obtained at a time of the depth synthesis mode from the recording portion 15, transmits the plurality of image pickup images to an unshown external device through a communication portion 17 by means of a communication control portion 11h, and acquires a synthesized image by depth synthesis at the external device. The communication control portion 11h is configured so that, upon receiving a synthesized image obtained by depth synthesis from an external device through the communication portion 17, the communication control portion 11h supplies the received synthesized image to the recording control portion 11d to cause the recording portion 15 to record the synthesized image.

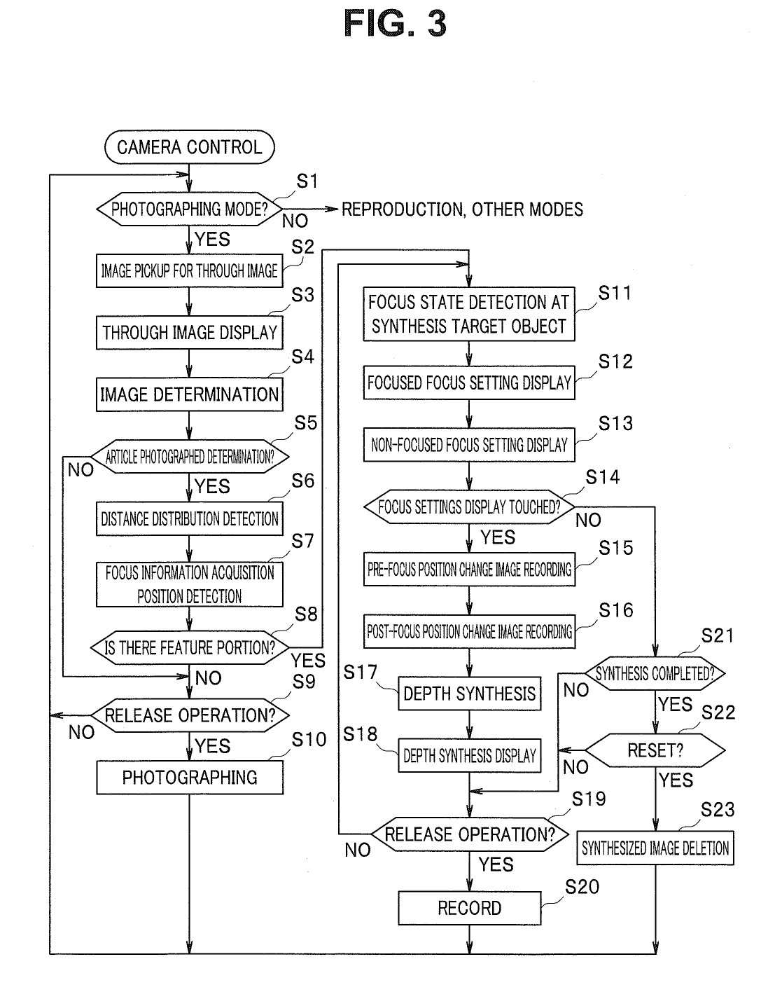

Next, operations of the embodiment configured in this manner are described referring to FIG. 3 to FIG. 7. FIG. 3 is a flowchart for describing operations of the embodiment.

In online selling in which products are sold through the Internet and the like, photographs of products on sale and the like are sometimes shown on websites. In the case of such a product photograph, it is normally better that the photograph is an image that is clear up to the detailed parts. However, in the case of photographing a product having a long portion in a depth direction, in some cases the object distances of the respective parts of the product differ by a relatively large amount. Therefore, in a case where the diaphragm is not closed or the object distance is too small, the focal depth of the photographing device becomes shallow and an image is photographed in which only one part of the product is in focus. In some cases, because it is difficult to check the focus state on the image that is displayed on the display screen of the display portion 16, the photographer uploads the photographic image as it is without being aware that part of the image is out of focus. In the present embodiment, even in a case where a photographer is not knowledgeable about the depth synthesis mode, in such a usage scene, photographing of an image that is in focus up to the detailed parts is facilitated.

In FIG. 3, an example is illustrated of performing photographing support for obtaining a clear image up to the detailed parts of a product by automatically transitioning to the depth synthesis mode when in a so-called “article photographing mode” when photographing such a kind of product. Note that a configuration may also be adopted so as to make a determination regarding various photographing scenes, and not just when performing article photographing, and transition to the depth synthesis mode as appropriate. Furthermore, naturally a configuration may also be adopted so as to transition to the depth synthesis mode when specified by a user operation.

In step S1 in FIG. 3, the control portion 11 determines whether or not the photographing mode is specified. If the photographing mode is not specified, the control portion 11 transitions to a different mode such as a reproduction mode.

If the photographing mode is specified, in step S2, the control portion 11 fetches an image pickup image from the image pickup portion 2. After performing predetermined signal processing on the image pickup image, the control portion 11 supplies the image pickup image to the display control portion 11e. The display control portion 11e supplies the image pickup image that has undergone the signal processing to the display portion 16 and causes the display portion 16 to display the image pickup image. Thus, a through image is displayed on the display screen of the display portion 16 (step S3).

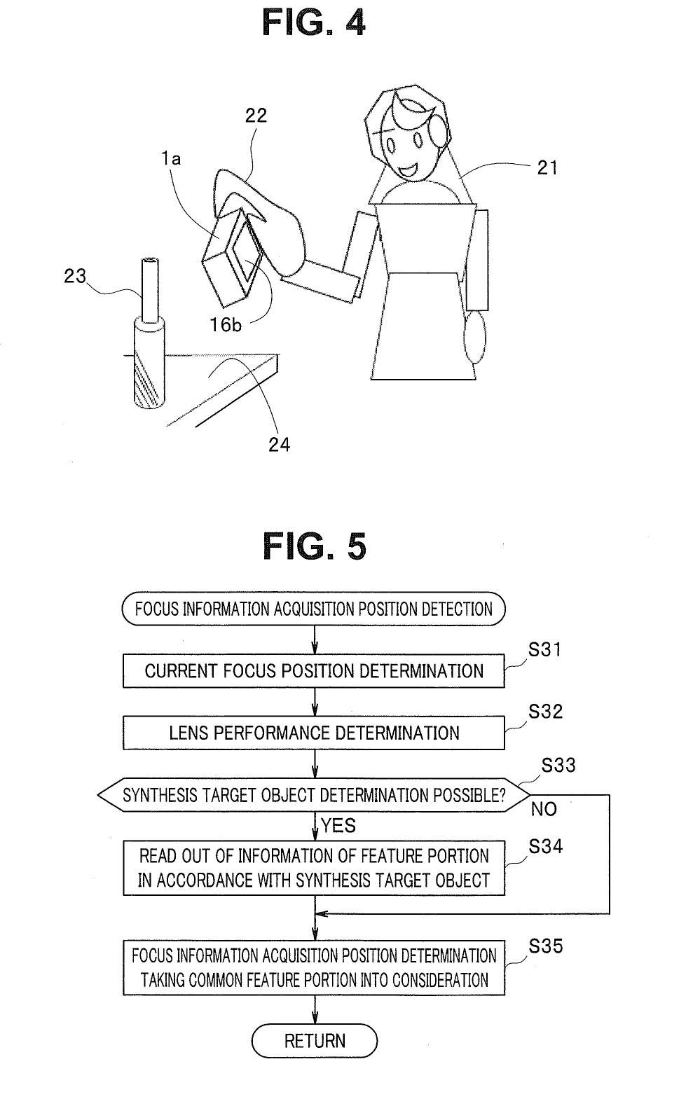

FIG. 4 is a view illustrating a way in which photographing is performed when performing article photographing. A bottle 23 that is merchandise (a product) is placed on a table 24. A user 21 grasps and sets a case 1a of the image pickup apparatus 1 in a right hand 22 so that the bottle 23 enters the field of view range. When in the photographing mode, in this state, a through image is displayed on a display screen 16b of the display portion 16 provided on the bask face of the image pickup apparatus 1. The user 21 performs photographing of the bottle 23 while checking the through image.

In step S4, the image determination portion 11a of the control portion 11 performs an image determination with respect to the image pickup image. For example, the image determination portion 11a can utilize feature values stored in the feature DB 15 or the like to determine whether an image included in the through image is an image of merchandise. The control portion 11 determines whether or not the user is attempting to perform article photographing based on the image determination with respect to the image pickup image (step S5).

In a case where the control portion 11 determines as a result of the image determination that article photographing is performed, the control portion 11 sets the article photographing mode and moves the processing to step S6. In contrast, if the control portion 11 determines that article photographing is not performed, the control portion 11 moves the processing to step S9. In step S9, the control portion 11 determines whether a release operation is performed. In step S9, if the control portion 11 detects that a photographing operation is performed by, for example, a user operation to push down the shutter button, in step S10, the control portion 11 performs photographing. In this case, an object is photographed in the normal photographing mode, and recording of an image pickup image is performed.

In the article photographing mode, the distance distribution is detected in step S6. The distance distribution determination portion 11b determines an object distance with respect to each portion of an image pickup image. Next, the control portion 11 detects a focus information acquisition position corresponding to a position at which an operation support display is displayed in the depth synthesis mode (step S7).

FIG. 5 is a flowchart illustrating an example of specific processing in step S7 in FIG. 3.

The continuity and focus state determination portion 11f of the control portion 11 determines the current focus position in step S31, and determines the lens performance in step S32. Next, the continuity and focus state determination portion 11f performs a determination with respect to a synthesis target object. Note that step S33 in FIG. 5 indicates that whether or not it is possible to determine a synthesis target object is determined by a comparison between a feature value stored in the feature DB 15a and an image analysis result. For example, the feature portion information shown in FIG. 2 is held in the feature DB 15a, and in a case where the photographing shown in FIG. 4 is performed, the continuity and focus state determination portion 11f can determine an image corresponding to the bottle 23 in the image pickup image as a synthesis target object. In this case, in step S34, the continuity and focus state determination portion 11f reads out information relating to a feature portion from the feature DB 15a.

Note that, it is also possible for the continuity and focus state determination portion 11f to detect a synthesis target object by determining the continuity of a contour line and an image, without utilizing the feature DB 15a. The continuity and focus state determination portion 11f determines focus information acquisition positions using information regarding common feature portions in addition to the information relating to a feature portion that is read out in step S34 (step S35). For example, a contour line within a range that is determined as being in focus, characters included within a synthesis target object, a repeated pattern, a vivid color pattern or the like are conceivable as common feature portions. The information for these common feature portions, including specific threshold values and the like, can also be stored in the feature DB 15a. The continuity and focus state determination portion 11f determines focus information acquisition positions on a synthesis target object based on the feature portion that is read out in step S34 and the information for common feature portions acquired in step S35.

The control portion 11 determines whether or not focus information acquisition positions are determined in the respective steps described above (step S8 in FIG. 3). Depending on the photographed object, there are also cases where a focus information acquisition position is not determined due to reasons such as that a feature portion does not exist. In this case, the control portion 11 moves the processing to step S9 to determine the existence/non-existence of a release operation.

If focus information acquisition positions are determined, the continuity and focus state determination portion 11f moves the processing from step S8 to step S11 to detect the focus state at each focus information acquisition position. Next, the continuity and focus state determination portion 11f provides information (focus information) regarding the focus state at the focus information acquisition positions to the display control portion 11e, to cause the display portion 16 to display a focus setting display (steps S12, S13).

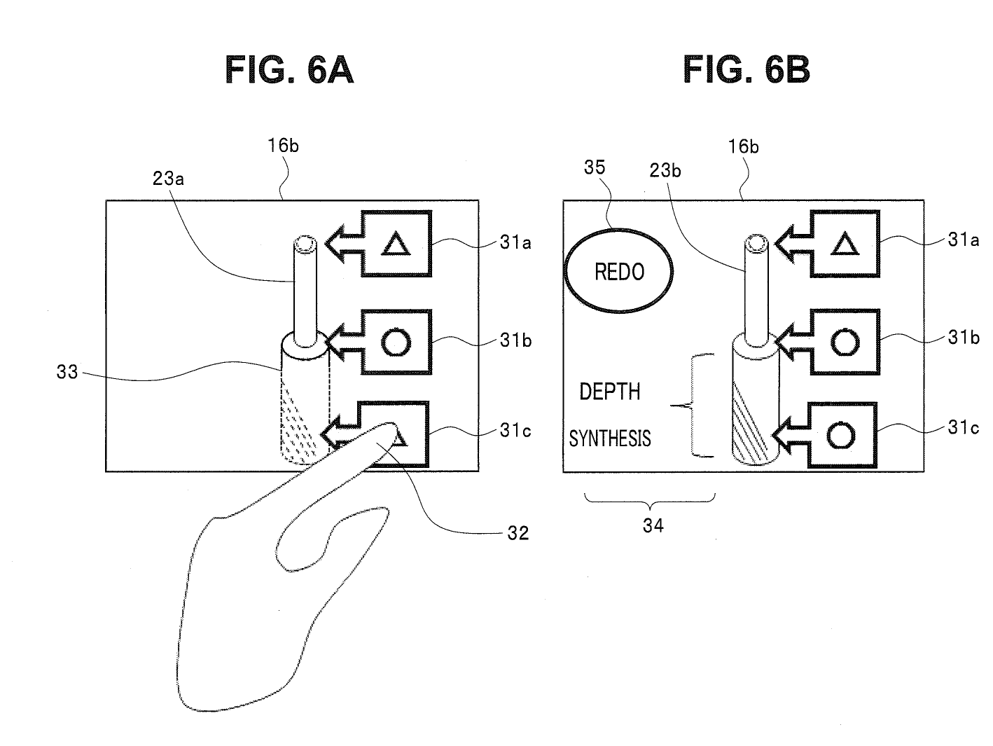

FIG. 6A and FIG. 6B are explanatory diagrams illustrating a display example of such kind of focus setting display. FIG. 6A and FIG. 6B correspond to photographing of the bottle 23 in FIG. 4. FIG. 6A illustrates an initial focus setting display. FIG. 6B illustrates a focus setting display after depth synthesis.

As shown in FIG. 6A, an image 23a of the bottle 23 that is the synthesis target object is displayed on the display screen 16b of the display portion 16. Note that a broken line part 33 in the image 23a indicates a portion which is not sufficiently in focus. The example shown in FIG. 6A and FIG. 6B illustrates a case where the top, the center and a label (not shown) portion in the vicinity of the bottom of the bottle 23 are set as focus information acquisition positions. Focus setting displays 31a to 31c corresponding to each of these focus information acquisition positions are displayed. The focus setting display 31b that includes a circular mark in FIG. 6A indicates that a focused focus setting display is displayed by means of step S12, and the focus setting displays 31a and 31c that include a triangular mark in FIG. 6A indicate that a non-focused focus setting display is displayed by means of step S13. Note that a focus setting display including a triangular mark indicates that although the current focus position is not in focus, focusing is possible by changing the focus position. Further, in step S13, a focus setting display that includes an “x” mark that indicates that the current focus position is not in focus and that focusing is not possible even if the focus position is changed.

When in the article photographing mode, the focus setting displays 31a to 31c are automatically displayed on a through image. Accordingly, when a user is photographing merchandise, the user can simply check the focus state. In addition, in the present embodiment, it is possible for a user to set a focus position at a time of depth synthesis, and if the user touches a focus setting display, image pickup is performed at a focus position that is in accordance with a focus information acquisition position corresponding to the focus setting display that is touched. For example, a configuration may also be adopted in which the display control portion 11e causes a message such as “Please touch a part that you want to bring into focus” to be displayed on the display screen 16b shown in FIG. 6A.

That is, in step S14, the continuity and focus state determination portion 11f determines whether or not the user performs such a touch operation on a focus setting display. For example, it is assumed that the user uses a finger 32 to touch the focus setting display 31c. The touch operation is detected by the touch panel 16a, and the continuity and focus state determination portion 11f receives a focus information acquisition position corresponding to the touched focus setting display 31c as a specified focusing position. The continuity and focus state determination portion 11f sets focus positions including a focus position that is based on a distance corresponding to the specified focusing position in the focus control portion 11c. The focus control portion 11c outputs a control signal for changing a focus position to the focus changing portion 3a so as to enable focusing at the specified focusing position. Thus, image pickup that is in focus is performed with respect to the specified focusing position that the user specifies.

The recording control portion 11d supplies the image pickup image before the focus position is changed to the recording portion 15 to record the image pickup image (step S15). Next, the recording control portion 11d supplies the image pickup image after the focus position is changed to the recording portion 15 to record the image pickup image. The depth synthesis portion 11i reads out the image pickup images before and after the focus position is changed from the recording portion 15 and performs depth synthesis (step S17). An image pickup image that is generated by the depth synthesis is displayed on the display portion 16 by the display control portion 11e (step S18).

In step S19, the control portion 11 determines whether or not a release operation is performed. If a release operation is not performed, the processing returns to step S11, in which the control portion 11 detects a focus state with respect to a synthesized image obtained by depth synthesis and displays focus setting displays.

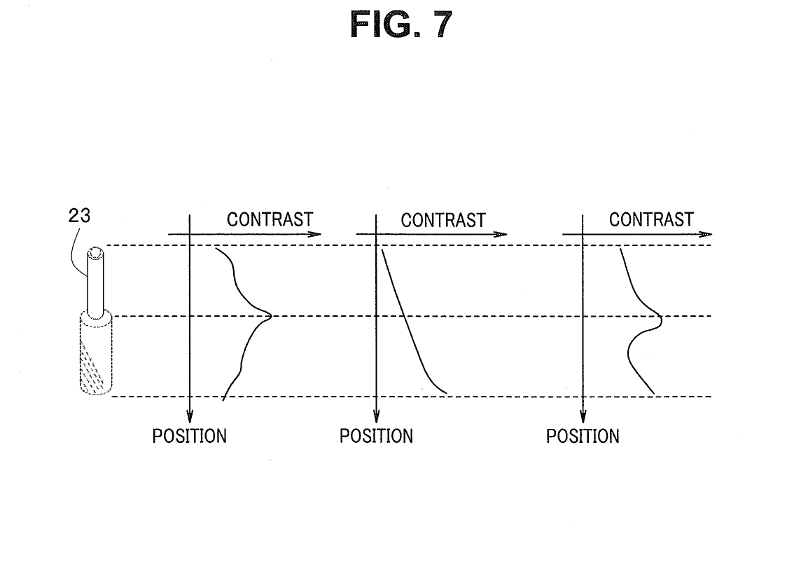

FIG. 6B illustrates a display example in this case. Further, FIG. 7 is an explanatory drawing illustrating changes in contrast in an image pickup image caused by depth synthesis. The vertical axis in FIG. 7 corresponds to a position in the vertical direction of the image of the bottle 23, and the horizontal axis represents contrast. A curved line on the left side shows the contrast before depth synthesis that corresponds to FIG. 6B, a curved line in the center shows the contrast of the image pickup image that is obtained after changing the focus position, and a curved line on the right side shows the contrast of the depth-synthesis image that corresponds to FIG. 6B.

The characteristic on the left side in FIG. 7 shows that in an image pickup image corresponding to FIG. 6B, an image portion corresponding to the center of the bottle 23 is in focus and the contrast is high at this portion. Further, the characteristic at the center in FIG. 7 shows that, as a result of the focus position being changed upon the user touching the focus setting display 31c, the bottom side of the bottle 23 is brought into focus, and an image pickup image is obtained in which the contrast is high at that portion. The characteristic on the right side in FIG. 7 is a characteristic that is obtained by synthesizing the characteristic on the left side and the characteristic at the center of FIG. 7, and shows that the contrast is high in an image portion corresponding to the center portion and bottom of the bottle 23 obtained by depth synthesis and the relevant image portion is in focus. Thus, a change in a focus state can be determined by means of a change in contrast or the like in a case where a focus position is changed.

In accordance with such a change in the focus state, as shown in FIG. 6B, the focus setting display 31c changes from the triangular mark indicating an out-of-focus state to the circular mark indicating an in-focus state. Further, a display 34 indicating that correction of the focus state was performed by depth synthesis is displayed at a portion corresponding to the focus setting display 31c and the like. By means of the display on the display screen 16b, the user can simply recognize that depth synthesis was performed and also recognize the results obtained by performing the depth synthesis.

If the user touches also another focus setting display, the processing transitions from step S14 to step S15 and the depth synthesis is repeated. If a focus setting display is not touched at the time of the determination in step S14, the processing transitions to step S21, and it is determined whether or not depth synthesis has been performed at least once time. In a case where depth synthesis has not been performed even one time, and a reset operation in not performed in the next step S22, the control portion 11 moves the processing to step S19 to enter a standby state for a touch operation by the user with respect to depth synthesis processing.

If depth synthesis has already been performed one or more times, the control portion 11 transitions from step S21 to step S22 to determine whether or not a reset operation has been performed. A reset display 35 for redoing is displayed on the display screen 16b by the display control portion 11e, and if the user touches the reset display 35, in step S23 the control portion 11 deletes the synthesized image.

If the control portion 11 detects in step S19 that the user performed a release operation, in step S20 the control portion 11 records the image pickup image that is stored in the recording portion 15, as a recorded image in the recording portion 15. That is, if the user performed a release operation without performing a touch operation on the focus setting display, an image pickup image for which depth synthesis is not performed is recorded, while if the user performed a release operation after performing a touch operation one or more times on the focus setting display, an image pickup image for which depth synthesis was performed is recorded.

Note that, although in the example illustrated in FIG. 3, when a focus setting display is touched, in steps S15 to S18 control is performed so that depth synthesis processing is performed and a focus state is obtained, a configuration may also be adopted so as to obtain a focus state by means of settings for the depth of field instead of depth synthesis processing. For example, if a touch operation is determined in step S14, the control portion 11 may determine whether or not a focus state is obtained based on the settings for the depth of field, and if it is determined that a focus state is obtained, the control portion 11 may control the lens control portion 3 so as to narrow the diaphragm, and then transition to step S19.

In the present embodiment that is configured as described above, in the depth synthesis mode, a synthesis target object that is a target for depth synthesis is detected, and the current focus state of each portion of the synthesis target object is shown by a guide display, and thus the user can easily recognize the focus state. In addition, a user can simply specify a position that the user wants to bring into focus by means of a touch operation on a screen, and thus effective specification for depth synthesis is possible. Further, by registering a position at which a focus state is to be displayed or a position that the user wants to bring into focus as feature portions, it is possible to automatically detect an image portion that is considered to be a portion that the user wants to bring into focus, and together with displaying a focus state, to specify the image portion as a focus position in depth synthesis. By this means, by performing an extremely simply operation, a reliable focusing operation is possible at a portion that the user wants to bring into focus. Further, the present embodiment is configured to determine a photographing scene based on an image pickup image of an object and automatically transition to the depth synthesis mode, and in a scene in which it is considered better to perform depth synthesis, a reliable focusing operation is possible without the user being aware that the focusing operation is performed. Thus, even a user who is not knowledgeable about depth synthesis can utilize depth synthesis relatively simply and obtain the benefits thereof.

In addition, although the respective embodiments of the present invention have been described using a digital camera as a device for photographing, as a camera it is also possible to use a lens-type camera, a digital single-lens reflex camera, a compact digital camera, a camera for moving images such as a video camera or a movie camera, and furthermore to use a camera incorporated into a cellular phone or a personal digital assistant (PDA) such as a smartphone or the like. Further, the camera may be an optical device for industrial or medical use such as an endoscope or a microscope, a surveillance camera, a vehicle-mounted camera, a stationary camera, or a camera that is attached to, for example, a television receiver or a personal computer.

The present invention is not limited to the precise embodiments described above, and can be embodied in the implementing stage by modifying the components without departing from the scope of the invention. Also, various inventions can be formed by appropriately combining a plurality of the components disclosed in the respective embodiments described above. For example, some components may be deleted from all of the disclosed components according to the embodiments. Furthermore, components from different embodiments may be appropriately combined.

Note that, even when words such as “first” and “next” are used for convenience in the description of operation flows in the patent claims, the specification, and the drawings, it does not mean that implementation must be performed in such order. Further, with respect to portions that do not affect the essence of the invention, naturally respective steps constituting these operation flows can be appropriately omitted.

Furthermore, among the technologies that are described herein, many controls or functions that are described mainly using a flowchart can be set by means of a program, and the above-described controls or functions can be realized by a computer reading and executing the relevant program. The whole or a part of the program can be recorded or stored as a computer program product on a storage medium such as a portable medium such as a flexible disk, a CD-ROM or the like or a non-volatile memory, or a hard disk drive or a volatile memory, and can be distributed or provided at a time of product shipment or on a portable medium or through a communication network. A user can easily implement the image processing apparatus of the present embodiment by downloading the program through the communication network and installing the program in a computer, or installing the program in a computer from a recording medium.

What is claimed is:

1. An image pickup apparatus, comprising:
an image pickup portion that obtains an image pickup image based on an object optical image obtained by an optical system that can vary a focus position;
an object distance determination portion that determines an object distance of each portion in the image pickup image;
a continuity determination portion that determines continuity of the object distance and the image pickup image; and
a display control portion that, in a depth synthesis mode that subjects a plurality of image pickup images that are obtained while varying a focus position of the optical system to depth synthesis, based on a determination result with respect to the continuity, causes a guide display for supporting the depth synthesis operation to be displayed on a display portion.

2. The image pickup apparatus according to claim 1, further comprising:
a focus state determination portion that determines a focus state with respect to an image portion that is determined as having continuity by the continuity determination portion;
wherein the display control portion causes a display that is based on a determination result with respect to the focus state to be displayed as the guide display on a display of the image pickup image.

3. The image pickup apparatus according to claim 2, wherein:
the focus state determination portion determines a focus state of an image portion that is determined as having continuity by the continuity determination portion with respect to a synthesized image that is obtained by the depth synthesis; and
the display control portion causes a display that is based on a determination result with respect to the focus state to be displayed as the guide display on a display of the synthesized image that is obtained by the depth synthesis.

4. The image pickup apparatus according to claim 2, wherein:
the focus state determination portion detects a feature portion that is based on information recorded in a feature database among image portions determined as having continuity by the continuity determination portion, and determines a focus state with respect to the feature portion that is detected.

5. The image pickup apparatus according to claim 3, wherein:
the focus state determination portion detects a feature portion that is based on information recorded in a feature database among image portions determined as having continuity by the continuity determination portion, and determines a focus state with respect to the feature portion that is detected.

6. The image pickup apparatus according to claim 1, further comprising:
a focus control portion that controls a focus position of the optical system;
wherein, in the depth synthesis mode, the focus control portion determines a focus position of the optical system based on a user operation with respect to the guide display.

7. The image pickup apparatus according to claim 1, further comprising:
a depth synthesis portion that subjects a plurality of image pickup images that are obtained while varying a focus position of the optical system to depth synthesis.

8. An operation support method that:
determines an object distance of each portion in an image pickup image from an image pickup portion that obtains the image pickup image based on an object optical image obtained by an optical system that can vary a focus position;
determines continuity of the object distance and the image pickup image; and
in a depth synthesis mode that subjects a plurality of image pickup images that are obtained while varying a focus position of the optical system to depth synthesis, based on a determination result with respect to the continuity, causes a guide display for supporting the depth synthesis operation to be displayed on a display portion.

9. A medium that records an operation support program for causing a computer to execute the steps of:
determining an object distance of each portion in an image pickup image from an image pickup portion that obtains the image pickup image based on an object optical image obtained by an optical system that can vary a focus position;
determining continuity of the object distance and the image pickup image; and
in a depth synthesis mode that subjects a plurality of image pickup images that are obtained while varying a focus position of the optical system to depth synthesis, based on a determination result with respect to the continuity, causing a guide display for supporting the depth synthesis operation to be displayed on a display portion.

10. An image pickup apparatus, comprising:
an image pickup portion that obtains an image pickup image based on an object optical image obtained by an optical system that can vary a focus position;
a display control portion that causes the image pickup image to be displayed on a display portion; and
a focus state determination portion that determines a focus state of each portion in the image pickup image, and in a depth synthesis mode that subjects a plurality of image pickup images that are obtained while varying a focus position of the optical system to depth synthesis, causes a guide display that is based on determination results with respect to the focus state before and after the depth synthesis to be displayed on the display control portion.

11. The image pickup apparatus according to claim 10, further comprising:
a focus control portion that controls a focus position of the optical system;
wherein, in the depth synthesis mode, the focus control portion determines a focus position of the optical system based on a user operation with respect to the guide display.
